(19) United States
(12) Patent Application Publication
(10) Pub. No.: US 2004/0021420 A1
(43) Pub. Date: Feb. 5, 2004

(54) Lamp unit and infrared night-vision system

(76) Inventors: Toshiaki Tsuda, Shizuoka-ken (JP); Hitoshi Takeda, Shizuoka-ken (JP); Masaya Shido, Shizuoka-ken (JP); Shinichi Irisawa, Shizuoka-ken (JP)

Correspondence Address: ROSENTHAL & OSHA L.L.P., 1221 MCKINNEY AVENUE, SUITE 2800, HOUSTON, TX, 77010, US

(21) Appl. No.: 10/379,327

(22) Filed: Mar. 4, 2003

(30) Foreign Application Priority Data
Mar. 6, 2002 (JP) 2002-60214

(51) Int. Cl. H01J 61/18; H01J 17/20

(52) U.S. Cl. 313/638

(57) ABSTRACT

A lamp unit for emitting near-infrared light by electric discharge, has: a hollow discharge tube; a cesium halide enclosed in the hollow of the discharge tube; a near-infrared penetration filter covering around the discharge tube. The cesium halide may include at least one of cesium iodide and cesium bromide. Also, an indium halide and thallium halide may further be enclosed in the hollow discharge tube.

This patent application claims priority based on a Japanese patent application, 2002-060214 filed on Mar. 6, 2002, the contents of which are incorporated herein by reference.

### BACKGROUND OF THE INVENTION

1. Field of the Invention

The present invention relates to a lamp unit and an infrared night-vision system. More particularly, the present invention relates to a lamp unit that emits a near-infrared light and an infrared night-vision system, which uses the lamp unit that emits a near-infrared light.

2. Description of the Related Art

Recently, the infrared night-vision system, or a night-vision system, is developed. The infrared night-vision system irradiates only the near-infrared light from a lamp and receives a reflected light by the light-receiving unit such as a CCD camera and displays an image based on the receipt light. This infrared night-vision system can detect a subject in front of a vehicle without generating glare, which is generated by the radiation of visible light from the vehicle.

In the infrared night-vision system, one of an example of the light source used for irradiating near-infrared light is a halogen bulb. The halogen bulb has a continuous spectrum distribution for the range from about 400 nm to about 2500 nm.

However, a halogen bulb has a continuous spectrum distribution depending on the light wavelength as explained above. Thus, the absolute value of the output in the near-infrared region of the halogen bulb used in an infrared night-vision system is small. Here, in order to increase the absolute value of the output in a near-infrared region of the halogen bulb, there is a way of increasing the terminal voltage for increasing the power consumption of the halogen bulb. However, if the halogen bulb is used with increased terminal voltage, disconnection and melanization, etc. of a filament in a halogen bulb will occur, and the durability and life of the halogen bulb will thus be decreased.

Moreover, as described in Japanese Patent Application Laid-Open No. 10-334849, there is an example of using cesium (Cs) as an enclosed object in a discharge tube for a headlight of the vehicle. However, the purpose of using cesium (Cs) in Japanese Patent Application Laid-Open No. 10-334849 was not for enabling a lamp system to use near-infrared irradiation, but for decreasing the change of the performance of the discharge tube on time or life durability such as stabilization of electric discharge and preventing a loss of transparency of an emission tube.

### SUMMARY OF THE INVENTION

Therefore, it is an object of the present invention to provide a lamp unit and an infrared night-vision system, which overcomes the above issues in the related art. This object is achieved by combinations described in the independent claims. The dependent claims define further advantageous and exemplary combinations of the present invention.

According to the first aspect of the present invention, a lamp unit for emitting near-infrared light by electric discharge, comprises: a hollow discharge tube; a cesium halide enclosed in the hollow of the discharge tube, and a near-infrared penetration filter covering around the discharge tube.

The near-infrared penetration filter may be provided such that the near-infrared penetration filter is removable from a circumference of the discharge tube. The cesium halide may include at least one of cesium iodide and cesium bromide. At least one of a metal halide selected from antimony, zinc, aluminum, iron, tin, nickel, titanium, bismuth, copper, holmium, lithium, niobium, palladium, tantalum, terbium, thorium, thallium, and rubidium or mercury may be further enclosed in the hollow discharge tube.

A proportion between one of the cesium iodide and cesium bromide to the mercury may satisfy the relation of 0.05≦M1/M2 ≦0.5; where M1 is mass (mg) of one of the cesium iodide and the cesium bromide; and M2 is mass (mg) of the mercury. A proportion between one of the cesium iodide and the cesium bromide to the metal halide may satisfy the relation of 0.25≦M1/M3≦4.0; where: M1 is mass (mg) of one of the cesium iodide and cesium bromide; and M3 is mass (mg) of the metal halide.

Sodium halide and rare earth halide may be enclosed in the hollow discharge tube. A proportion between one of the cesium iodide and cesium bromide to the sodium halide and rare earth halide may satisfy the relation of 0.25≦M1/M4≦4.0; where M1 is mass (mg) of one of the cesium iodide and the cesium bromide; and M4 is mass (mg) of the sodium halide and the rare earth halide. The sodium halide may include at least one of sodium iodide (NaI) and sodium bromide (NaBr). The rare earth halide may include scandium compound (ScI3). At least one of indium halide and thallium halide may be further enclosed in the hollow discharge tube.

According to the second aspect of the present invention, an infrared night-vision system, comprising: a lamp unit having a hollow discharge tube; cesium halide enclosed in the hollow of the discharge tube; a near-infrared penetration filter covering around the discharge tube; and the lamp unit emits near-infrared light by electric discharge; a light-receiving unit for receiving light reflected from irradiated subject based on near-infrared light, which is emitted from the lamp unit; and a display unit that displays an image based on the reflected light received by the light-receiving unit.

This summary of the invention does not necessarily describe all necessary features of the present invention. The present invention may also be a sub-combination of the above-described features. The above and other features and advantages of the present invention will become more apparent from the following description of embodiments taken in conjunction with the accompanying drawings.

### BRIEF DESCRIPTION OF THE DRAWINGS

FIG. 1 shows an exploded perspective view of a lamp unit of the first embodiment.

FIG. 2 shows a sectional view of the lamp unit shown in FIG. 1.

FIG. 3 shows the measured result of the tube voltages VL of emission in these discharge tubes.

FIG. 4 shows a measured spectrum distribution of one unit of discharge tube 20 of the second example.

FIG. 5 shows a spectrum distribution of the lamp unit 10, which has the discharge tube 20 and the infrared filter 30.

FIG. 6 shows a sensitivity characteristic distribution of the infrared night-vision system.

FIG. 7 shows an integrated value of the near-infrared illuminance and an integrated value of the sensitivity characteristic of the near-infrared night-vision system in the second example.

FIG. 8 shows all luminous flux of the light emitted from the discharge tubes.

FIG. 9 shows the standard of radiation illuminance required as a halogen lamp is taking into consideration as a reference.

FIG. 10 shows the measured result of the tube voltages VL of emission in these discharge tubes.

FIG. 11 shows a configuration of the infrared night-vision system 100 according to the present embodiment.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

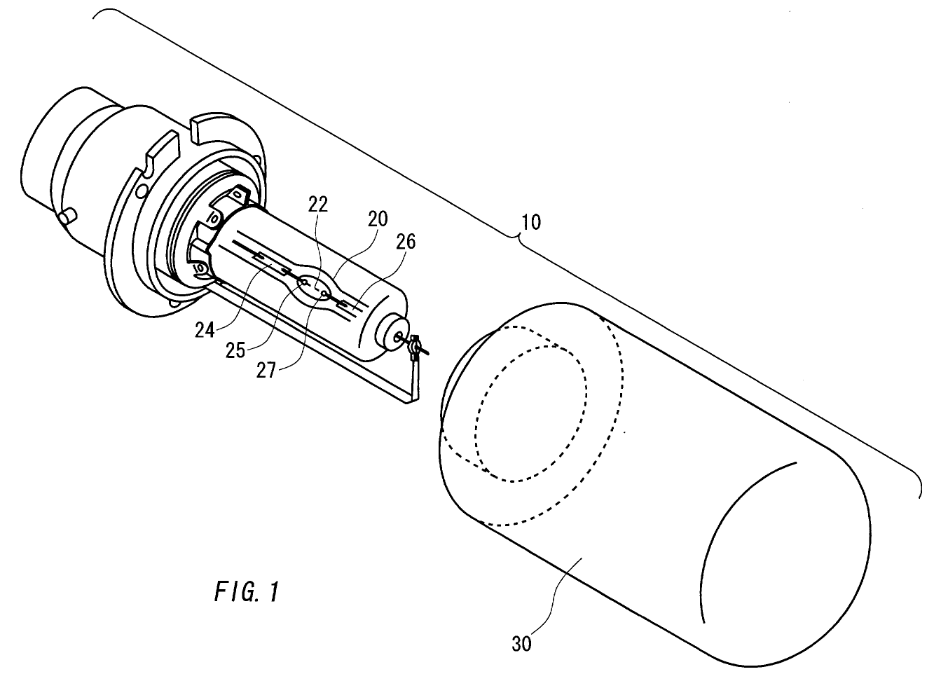

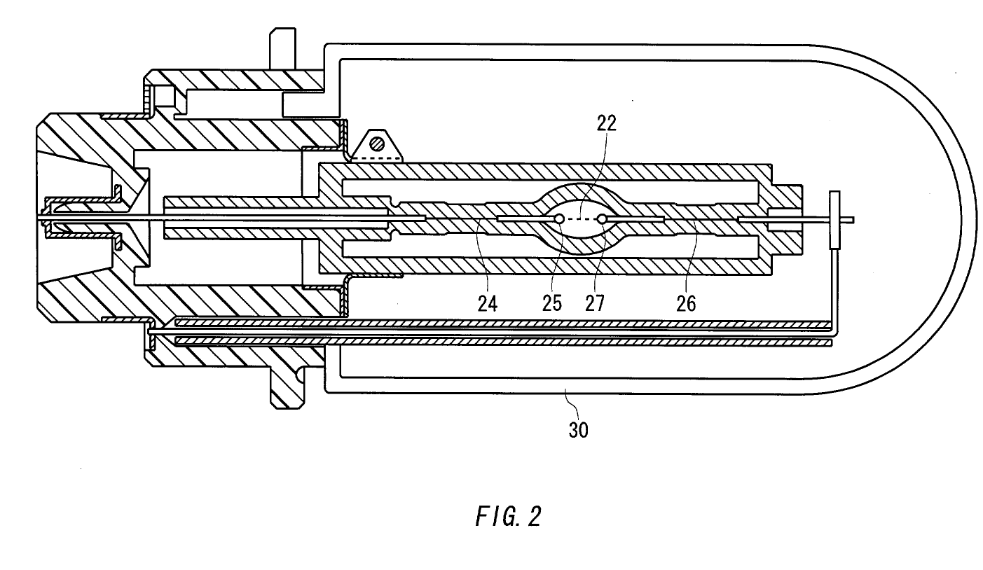

FIG. 1 shows an exploded perspective view of a lamp unit of the first embodiment. FIG. 2 shows a sectional view of the lamp unit shown in FIG. 1.

The lamp unit 10 has a hollow discharge tube 20. In this embodiment, the discharge tube 20 has a first electrode 24 and a second electrode 26, and the tips 25 and 27 of each of the electrodes 24 and 26 are enclosed in the hollow 22 of the discharge tube 20. However, the present embodiment is not limited to this example. A discharge tube of an electrodeless discharge lamp may be used for the present embodiment. In addition, the configuration of the lamp unit as described in Japanese Patent Application Laid-Open No. 11-176319 can be used for the configuration of the lamp unit 10.

A cesium halide is enclosed in the hollow 22 of a discharge tube 20. In the present embodiment, a cesium halide includes cesium iodide (CsI). However, the present embodiment is not limited to cesium iodide. For example, the cesium halide may include cesium bromide (CsBr).

In the hollow 22 of this discharge tube 20, mercury (Hg) is further enclosed. Preferably, the proportion between one of cesium iodide and cesium bromide to mercury satisfies the relation of 0.05≦M1/M2≦0.5. Here, M1 is mass (mg) of one of the cesium iodide and the cesium bromide, and M2 is mass (mg) of the mercury.

The lamp unit 10 further comprises a near-infrared penetration filter 30 covering around the discharge tube 20. In the present embodiment, the near-infrared penetration filter 30 has a cylindrical form, one side of which is opened. The discharge tube 20 is inserted from the opening of the near-infrared penetration filter 30, and the near-infrared penetration filter 30 is installed on the lamp unit 10 so that the whole discharge tube 20 is covered. The light having wavelength longer than about 780 nm penetrates through the near-infrared penetration filter 30. On the other hand, the light having wavelength shorter than about 780 nm is intercepted by the near-infrared penetration filter.

In the present embodiment, although the near-infrared penetration filter 30 has a cylindrical form, one side of which has an opening, the form of the near-infrared penetration filter 30 is not limited to the cylindrical form. Another example of the near-infrared penetration filter 30 is the near-infrared penetration filters which is deposited inside an outer lens or an inner lens of a headlight. Other examples are the special filter having a non-cylindrical form, such as a planer form arranged among these lenses and discharge tube.

The near-infrared penetration filter 30 may be formed such that the near-infrared penetration filter 30 can retreat from the circumference of a discharge tube 20. For example, the near-infrared penetration filter 30 may be installed on the lamp unit 10 so that the near-infrared penetration filter 30 can be removed from the lamp unit 10. In this case, the lamp unit 10 can be used for both of the headlight of vehicles and an infrared night-vision system.

High pulse voltage is applied between the first electrode 24 and the second electrode 26, and the discharge tube 20 in the lamp unit 10 emits light by electric discharge. Among the light emitted from the discharge tube 20, the near-infrared light penetrates through the near-infrared penetration filter 30, while the visible light is intercepted by the near-infrared penetration filter 30. In addition, near-infrared referred here means the light, which has the wavelength of the range about 780 nm to 1500 nm.

In this way, the lamp unit 10 of the first embodiment outputs only the near-infrared light and intercepts the visible light. The CCD camera of the infrared night-vision system has a high sensitivity characteristic to this near-infrared light. Therefore, this lamp unit 10 can be used for a light source of the infrared night-vision system.

Here, the main factor that decides the wavelength of the light emitted from the discharge tube 20 is the wavelength of the emitted light of the cesium (Cs) enclosed in the discharge tube 20. In case of the cesium, the emitted light mainly exists in near-infrared band from 795 nm to 921 nm, which is required by the infrared night-vision system. Conversely, a large spectrum does not exist in a visible region, which must be intercepted by the near-infrared penetration filter 30. Especially, a large spectrum does not exist in the region from the visible region to the infrared light boundary region (from 700 nm to 780 nm). Thus, the design of a near-infrared penetration filter 30 becomes easy.

Therefore, the lamp unit 10 of the first embodiment can output near-infrared light efficiently. Thereby, the lamp unit 10 of the first embodiment can be used as a light source, which has lower power consumption and longer life than a halogen bulb. Moreover, the amount of each of visible light and the near-infrared radiation can be designed by changing the quantity of an enclosed cesium.

### FIRST EXAMPLE

The lamp unit 10 of the first embodiment is further explained in this first example. In the first example, the cesium halide and the mercury are enclosed in the hollow 22 of the discharge tube 20 of the above-mentioned lamp unit 10. Here, CsI is enclosed as a cesium halide. The discharge tubes having 8×6=48 types of combinations of the quantity M1 of CsI and the quantity M2 of mercury were manufactured. The quantity M1 of CsI was varied from 0.05 mg to 0.40 mg, and the quantity M2 of mercury was varied from 0.4 mg to 1.4 mg.

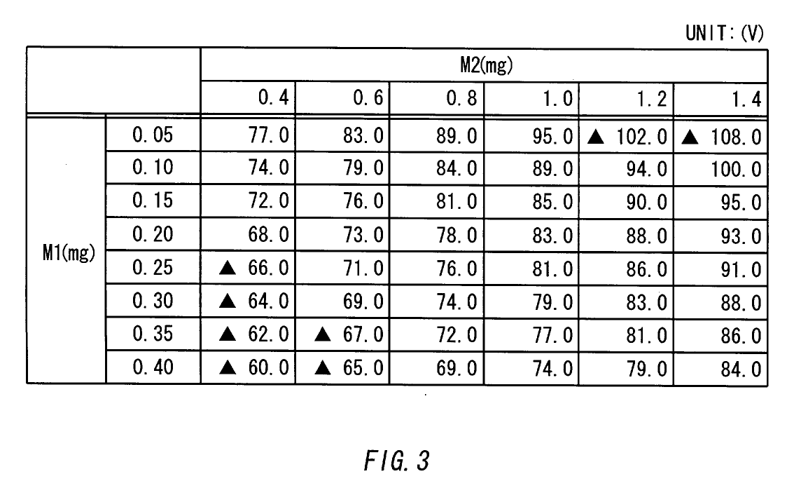

FIG. 3 shows the measured result of the tube voltages VL of emission in these discharge tubes. The standard required as a headlight of vehicles is taking into consideration, and the black triangle mark was given to the discharge tube that does not satisfy the criterion of VL=85±17 (V) as shown in FIG. 3. As shown in FIG. 3, in order to meet this criterion, it is desirable to design the discharge tube so that the quantity M1 of CsI and the quantity M2 of mercury satisfy the relation of 0.05≦M1/M2≦0.5.

Sodium compound may further be enclosed in the hollow 22 of the discharge tube 20 of the lamp unit 10 of the first embodiment. One of an example of the sodium compound is sodium iodide (NaI). However, the present embodiment is not limited to the sodium iodide (NaI), and sodium bromide (NaBr) maybe used as the sodium compound. Furthermore, both of the sodium iodide and sodium bromide may be enclosed in the hollow 22 of the discharge tube 20.

Sodium (Na) has an emission wavelength including a yellow peak around wavelength of 590 nm and the near-infrared peak around the wavelength of 820 nm. Furthermore, the sodium does not include a peak at the visible long-wavelength region, and the spectrum distribution in this region is small so that it can be ignored.

This lamp unit 10 can output near-infrared light further efficiently because the spectrum distribution in the near-infrared region becomes larger by enclosing the sodium compound in the hollow 22 of the discharge tube 20.

Also, rare earth halide may further be enclosed in the hollow 22 of the discharge tube 20 in the above-mentioned lamp unit 10. A scandium compound (ScI3) is an example of rare earth halide to be enclosed in the hollow 22 of the discharge tube 20.

The cesium and sodium, which include a large spectrum distribution in the near-infrared region, and scandium, which includes a large spectrum distribution in the visible light region are enclosed in the discharge tube 20 of this lamp unit. Therefore, the light emitted from the discharge tube 20 of this lamp unit 10 contains near-infrared light and visible light.

This lamp unit 10 can be used as the light source for irradiating the visible light such as a headlight of a vehicle, for example by removing the infrared penetration filter 30 from the lamp unit 10. Furthermore, by mounting the infrared penetration filter 30 on the lamp unit 10, the lamp unit 10 can be used as a light source for outputting the near-infrared light, such as electric discharge light for an infrared night-vision system as the above-mentioned lamp unit 10. Thereby, this lamp unit 10 can be used for both of the light source for irradiating the visible light and the light source for irradiating the near-infrared light.

Moreover, the spectrum distribution of the yellow in the emitted light of the discharge tube 20 is large when the ratio of the sodium compound enclosed in the discharge tube 20 is high. Therefore, the lamp unit 10 may be used as a light source for irradiating the yellow light such as fog lamp for a vehicle by removing the infrared penetration filter 30 from the lamp unit 10. Furthermore, by mounting the infrared penetration filter 30 on the lamp unit 10, the lamp unit 10 can be used as a light source for outputting the near-infrared light as the above-mentioned lamp unit 10. Thereby, this lamp unit 10 can be used for both of the light source for irradiating the yellow light and the light source for irradiating the near-infrared light.

As mentioned above, the lamp unit 10 can be used for both of the light source for irradiating the near-infrared light and the light source for irradiating the visible light or yellow light by removably mounting the infrared penetration filter 30 on the lamp unit 10. The selection between the visible light and the yellow light can be controlled by controlling the quantity of the sodium compound enclosed in the hollow 22 of the discharge tube 20 of the lamp unit 10.

### SECOND EXAMPLE

The lamp unit 10 of the above-mentioned embodiment is further explained using a second example. As an example of the lamp unit 10, the discharge tubes 20 shown in FIGS. 1 and 2 were used. 0.15 mg of cesium iodide, 0.9 mg of mercury, 0.3 mg of iodide sodium iodide and scandium iodide, the proportion of which is 65 to 35, were enclosed in the hollow 22 of a discharge tube 20.

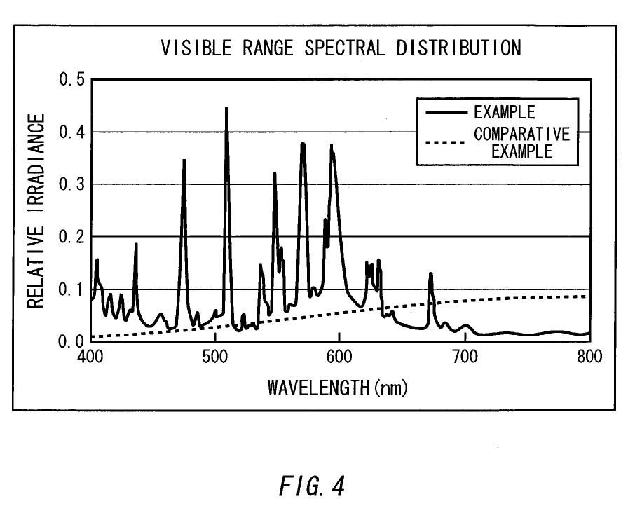

FIG. 4 shows a measured spectrum distribution of one unit of discharge tube 20 of the second example in the visible light region depending on the light wavelength when the electric power of a discharge tube 20 is 35 W. In FIG. 4, a spectrum distribution of the discharge tube 20 of the second example in the wavelength range from 400 nm to 800 nm is shown.

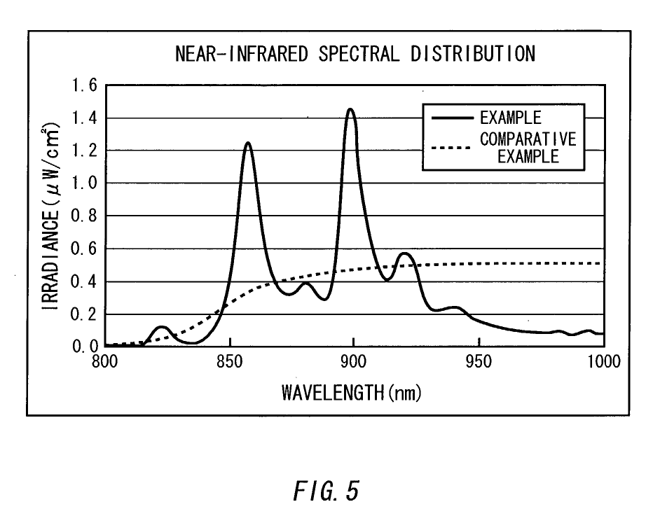

FIG. 5 shows a spectrum distribution of the lamp unit 10, which has the discharge tube 20 and the infrared filter 30. In FIG. 5, a spectrum distribution of the near-infrared light of the discharge tube 20 of the second example in the wavelength range from 800 nm to 1000 nm is shown.

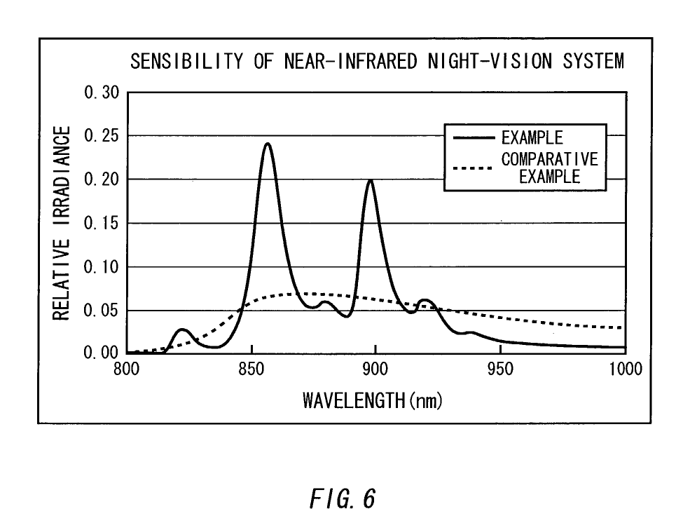

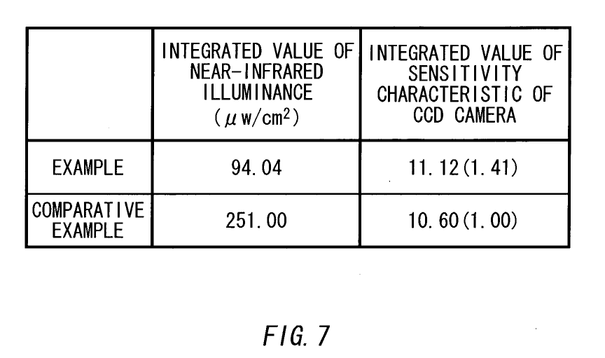

FIG. 6 shows a sensitivity characteristic distribution of the infrared night-vision system depending on the light wavelength. FIG. 7 shows an integrated value of the near-infrared illuminance and an integrated value of the sensitivity characteristic of the near-infrared night-vision system in the second example. In FIG. 7, the integrated value is taken from the range from 800 nm to 1000 nm.

Furthermore, as a comparative example, a spectrum distribution depending on the light wavelength and the sensitivity characteristic distribution of the infrared night-vision system were measured for a halogen bulb as the second example and were shown in FIGS. 4 to 6. Here, the terminal voltage of the halogen bulb was set to 12 V. An integrated value of the near-infrared illuminance and an integrated value of the sensitivity characteristic of the infrared night-vision system in this comparative example were shown in FIG. 7.

The integrated value of the near-infrared illuminance and an integrated value of the sensitivity characteristic of a CCD camera of the second example are greater than that of comparative example. Therefore, the second example can output near-infrared light efficiently. Thereby, as compared with the comparative example, the second example can be used as a light source that irradiates a light, to which the CCD camera of the infrared night-vision system is highly sensitive.

Furthermore, the comparative example has a spectrum distribution, which is continuous from the visible long-wavelength region to a near-infrared region. In contrast with the comparative example, the second example has a spectrum distribution, the visible long-wavelength region of which can be ignored, and the spectrum distribution contains plurality of large peaks in the near-infrared region.

Therefore, in the present embodiment, it is easy to design the infrared penetration filter 30 for the light wavelength. Especially, the design of the infrared penetration filter 30 is easy even when the visible light must be intercepted as in the case of the infrared penetration filter 30 is used as a light source for the infrared night-vision system for a vehicle. Moreover, the present embodiment can outputs the light in the required region efficiently.

### THIRD EXAMPLE

The lamp unit 10 is further explained in a third example. Cesium halide, mercury, sodium halide, and rare earth halide are enclosed in the hollow 22 of the discharge tube 20 of the lamp unit 10 of the third example. Here, CsI is enclosed in the hollow 22 of the discharge tube 20 as cesium halide. Moreover, NaI is enclosed in the hollow 22 of the discharge tube 20 as a sodium halide, and ScI₃ is enclosed in the hollow 22 of the discharge tube 20 as a rare earth halide with the NaI.

The discharge tubes having 8×7=56 types of combinations of the quantity M1 of CsI and the total quantity M4 of NaI and ScI were manufactured. The quantity M1 of CsI was varied from 0.05 mg to 0.40 mg, and the total quantity M4 of NaI and ScI was varied from 0.03 mg to 0.3 mg.

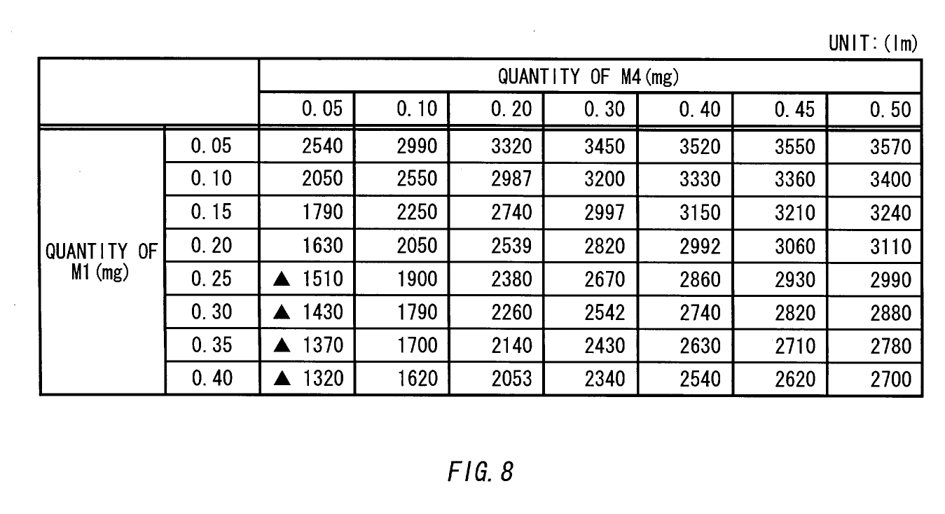

FIG. 8 shows all luminous flux of the light emitted from the discharge tubes.

The standard of luminous flux required as a halogen lamp is taking into consideration as a reference, and the black triangle mark was given to the discharge tube that does not satisfy the criterion of all luminous flux ≧1550 as shown in FIG. 8. Furthermore, a calculated value of a radiation illuminance IR is calculated from the predetermined measured values such as sensitivity of infrared night-vision system.

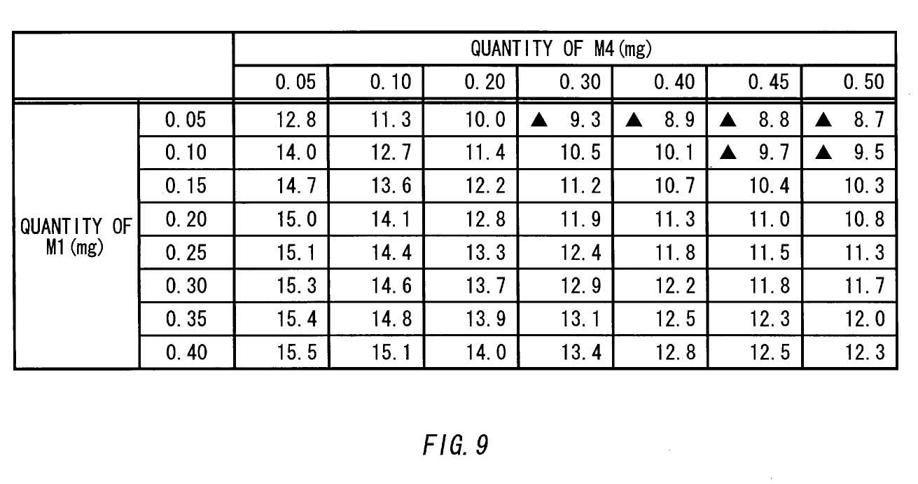

The standard of radiation illuminance required as a halogen lamp is taking into consideration as a reference, and the black triangle mark was given to the discharge tubes that does not satisfy the criterion of IR≧10.0 as shown in FIG. 9. As shown in FIGS. 8 to 9, in order to satisfy this criterion, it is desirable to design the discharge tube so that the quantity M1 of CsI and the total quantity M4 of NaI and ScI satisfy the relation of 0.25≦M1/M4≦4.0.

In the above-mentioned lamp unit 10, indium halide may be further enclosed in the hollow 22 of a discharge tube 20. Indium halide restrains the increase of the chromaticity X of the emitted light of the cesium halide in the hollow 22 and limits the chromaticity X of the emitted light to a white region. Therefore, the lamp unit 10, in which the indium halide is enclosed, can be used not only as a light source for the infrared night-vision system but also as a light source, which is approximate to a natural color even if it is used for a headlight of a vehicle.

Moreover, in the above-mentioned lamp unit 10, a thallium halide may further be enclosed in the hollow 22 of the discharge tube 20. Thallium halide restrains the decrease of all luminous flux of the light emitted by the cesium halide in the hollow 22. Therefore, the lamp unit 10, in which the thallium halide is enclosed, can be used not only as a light source for the infrared night-vision system but also as a light source that maintains full power even if it is used for a headlight of a vehicle.

What is enclosed in the discharge tube 20 is different between the lamp unit 10 of the first embodiment and the lamp unit 10 of the second embodiment. In the first embodiment, mercury is enclosed as mentioned above. In contrast with the first embodiment, one sort or a plurality sorts of a metal halide chosen from antimony (Sb), Zinc (Zn), aluminum (AL), iron (Fe) Tin (Sn), Nickel (Ni), titanium (Ti), Bismuth (Bi), copper (Cu), holmium (Ho), lithium (Li), niobium (Nb), palladium (Pd), tantalum (Ta), terbium (Tb), thorium (Th), thallium (Tl), and rubidium (Rb) is enclosed instead of mercury in the second embodiment.

When one sort or a plurality sorts of the above-mentioned metal halide is enclosed in the discharge tube 20, the proportion of one of the cesium iodide and cesium bromide to the metal halide preferably satisfies the relation of 0.25≦M1/M3≦4.0. Here, M1 is mass (mg) of one of the cesium iodide and cesium bromide, and M3 is mass (mg) of the metal halide.

Here, a sodium compound may further be enclosed in the hollow 22 of the discharge tube 20 by the lamp unit 10 in the second embodiment as in the first embodiment. One of an example of sodium compound is sodium iodide (NaI). However, the present embodiment is not limited to the sodium iodide (NaI), and sodium bromide (NaBr) may be used as the sodium compound. Furthermore, both of the sodium iodide and sodium bromide may be enclosed in the hollow 22 of the discharge tube 20. In this case, as in the lamp unit 10 of the second embodiment, the lamp unit 10 of the third example can output near-infrared light further efficiently because the spectrum distribution in the near-infrared region becomes larger by enclosing the sodium compound in the hollow 22 of the discharge tube 20.

Also, rare earth halide may further be enclosed in the hollow 22 of the discharge tube 20 of the above-mentioned lamp unit 10 as in the first embodiment. A scandium compound (ScI3) is an example of rare earth halide to be enclosed in the hollow 22 of the discharge tube 20. In this case, the lamp unit 10 can be used for both of the light source for irradiating the near-infrared light and the light source for irradiating the visible light or yellow light as in the first embodiment. The selection between the visible light and the yellow light can be controlled by controlling the quantity of the sodium compound enclosed in the hollow 22 of the discharge tube 20 of the lamp unit 10.

As mentioned above, the second embodiment can achieve the same effect as the first embodiment. Furthermore, since the second embodiment does not use the mercury, which is toxic substance that pollutes environment, the second embodiment can respond to the social needs such as reducing the cause of the environmental pollution on the earth as much as possible.

### FOURTH EXAMPLE

The lamp unit 10 of the second embodiment is further explained in the fourth example. In the fourth example, the cesium halide and the metal halide are enclosed in the hollow 22 of the discharge tube 20 of the lamp unit 10. Here, CsI is enclosed as a cesium halide. The discharge tubes having 8×7=56 types of combinations of the quantity M1 of CsI and the quantity M3 of metal halide were manufactured. The quantity M1 of CsI was varied from 0.05 mg to 0.40 mg, and the quantity M3 of metal halide was varied from 0.03 mg to 0.30 mg.

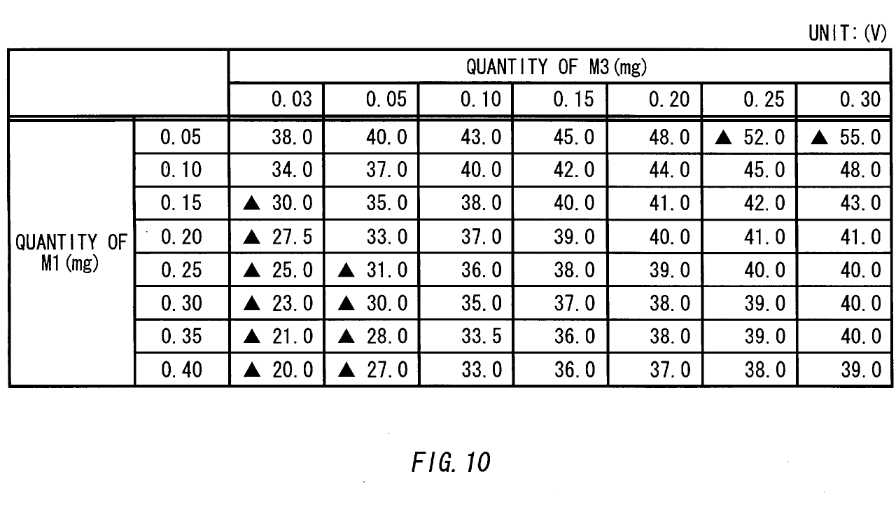

FIG. 10 shows the measured result of the tube voltages VL of emission in these discharge tubes. The standard required as a headlight of vehicles, which does not use mercury, is taking into consideration, and the black triangle mark was given to the discharge tube that does not satisfy the criterion of VL=42±9 (V) as shown in FIG. 3. As shown in FIG. 3, in order to meet this criterion, it is desirable to design the discharge tube so that the quantity M1 of CsI and the quantity M3 of metal halide satisfy the relation of 0.25≦M1/M3≦4.0.

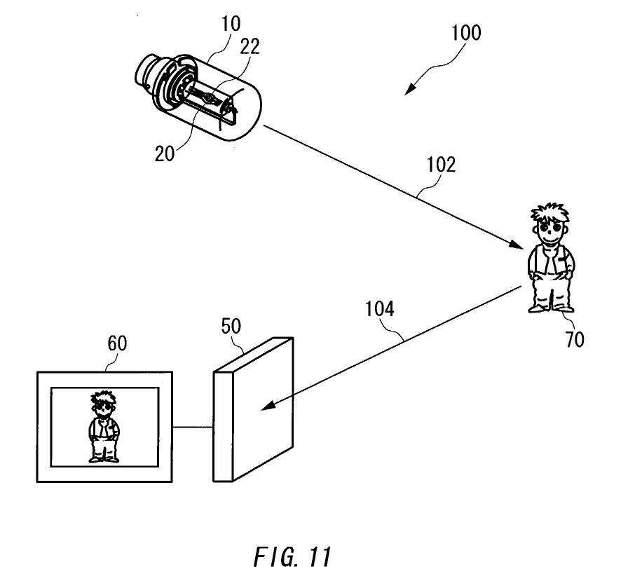

FIG. 11 shows a configuration of the infrared night-vision system 100 according to the present embodiment. The infrared night-vision system 100 is used for checking the existence of a subject in front of a vehicle at night.

The infrared night-vision system 100 has the lamp unit 10 as same as the first embodiment. This lamp unit 10 has a hollow discharge tube 20 and cesium compound enclosed in the hollow 22 of the discharge tube 20 as in the first embodiment. The lamp unit 10 emits near-infrared light by electric discharge. The lamp unit 10 may have an infrared penetration filter, which intercepts visible light, and the light having longer wavelength than that of near-infrared light penetrates the infrared penetration filter.

The infrared night-vision system 100 further comprises a light-receiving unit 50 that receives a reflected light 104 reflected from the subject 70 based on the near-infrared light 102 emitted from the lamp unit 10. An example of the light-receiving unit 50 is a CCD camera. The infrared night-vision system 100 further comprises a display unit 60, which displays an image based on the reflected light received by the light-receiving unit 50.

In this infrared night-vision system 100, the lamp unit 10 emits the near-infrared light 102 and irradiates the subject. The cesium compound is enclosed in the hollow 20 of the discharge tube 20 of the lamp unit 10. Therefore, the lamp unit 10 outputs the light in near-infrared region efficiently as the first embodiment. The light-receiving unit 50 receives the reflected light 104 reflected from the subject 70 among the near-infrared light 102, which is emitted from the lamp unit 10. The light-receiving unit 50 outputs signal based on the received reflected light 104. The display unit 60 displays the image corresponding to the subject 70, to which the near-infrared light 102 is irradiated by the lamp unit 10, based on the signal output from the light-receiving unit 50.

As mentioned above, according to the present embodiment, the infrared night-vision system 100 can check the subject 70 using the near-infrared light 102, which is output from the lamp unit 10 with high-efficiency. Especially, as shown in FIG. 7, the infrared night-vision system 100 can irradiates a light, to which the light-receiving unit 50 such as CCD has a high sensitivity, from the lamp unit 10. Thus, the infrared night-vision system 100 can check the subject 70 correctly.

The lamp unit 10 of the infrared night-vision system 100 according to the present embodiment has life longer than the life of the halogen bulb. Furthermore, the lamp unit 10 of the infrared night-vision system 100 according to the present embodiment has power consumption lower than the power consumption of the halogen bulb. Moreover, as shown in FIG. 7, since the quantity of infrared radiation irradiated from the lamp unit 100 of the infrared night-vision system 100 is few, the influence on a human body by the infrared radiation irradiated from the lamp unit 100 is small.

Moreover, when the infrared night-vision system 100 is used for checking the subject in front of a vehicle, an infrared penetration filter is used for intercepting the visible long-wavelength light (red-light) in front the vehicle. In the lamp unit 10 of the infrared night-vision system 100, the integrated value of the radiation illumination of the near-infrared light generated by electric discharge of the discharge tube 20 is larger than the integrated value of the radiation illumination of the light of visible long-wavelength region generated by the electric discharge of the discharge tube 20. Therefore, it is easy to design an infrared penetration filter of the lamp unit 10 of the infrared night-vision system 100 for the light wavelength.

As clear from the above-explanation, the lamp unit according to the present embodiment can output the near-infrared light efficiently. Thereby, the lamp unit of the present embodiment can be used as a light source for near-infrared light, the life of which is longer than the life of a halogen bulb, and the power consumption of which is lower than the power consumption of a halogen bulb. Moreover, according to the present embodiment, it is easy to design the infrared penetration filter for the light wavelength of the lamp unit that outputs near-infrared light.

Although the present invention has been described by way of exemplary embodiments, it should be understood that many changes and substitutions may be made by those skilled in the art without departing from the spirit and the scope of the present invention which is defined only by the appended claims.

What is claimed is:

1. A lamp unit for emitting near-infrared light by electric discharge, comprising:
a hollow discharge tube;
a cesium halide enclosed in said hollow of said discharge tube; and
a near-infrared penetration filter covering around said discharge tube.

2. A lamp unit as claimed in claim 1, wherein: said near-infrared penetration filter is provided such that said near-infrared penetration filter is removable from a circumference of said discharge tube.

3. A lamp unit as claimed in claim 1, wherein: said cesium halide includes at least one of cesium iodide and cesium bromide.

4. A lamp unit as claimed in claim 3, wherein: at least one of a metal halide selected from antimony, zinc, aluminum, iron, tin, nickel, titanium, bismuth, copper, holmium, lithium, niobium, palladium, tantalum, terbium, thorium, thallium, and rubidium or mercury is further enclosed in said hollow discharge tube.

5. A lamp unit as claimed in claim 4, wherein: a proportion between one of said cesium iodide and cesium bromide to said mercury satisfy the relation of 0.05≦M1/M2≦0.5; where M1 is mass (mg) of one of said cesium iodide and said cesium bromide; and M2 is mass (mg) of said mercury.

6. A lamp unit as claimed in claim 4, wherein: a proportion between one of said cesium iodide and said cesium bromide to said metal halide satisfy the relation of 0.25≦M1/M3≦4.0; where: M1 is mass (mg) of one of said cesium iodide and cesium bromide; and M3 is mass (mg) of said metal halide.

7. A lamp unit as claimed in claim 3, wherein sodium halide and rare earth halide are enclosed in said hollow discharge tube.

8. A lamp unit as claimed in claim 7, wherein: a proportion between one of said cesium iodide and cesium bromide to said sodium halide and rare earth halide satisfy the relation of 0.25≦M1/M4≦4.0; where M1 is mass (mg) of one of said cesium iodide and said cesium bromide; and M4 is mass (mg) of said sodium halide and said rare earth halide.

9. A lamp unit as claimed in claim 7, wherein said sodium halide includes at least one of sodium iodide (NaI) and sodium bromide (NaBr).

10. A lamp unit as claimed in claim 7, wherein said rare earth halide includes scandium compound (ScI3).

11. A lamp unit as claimed in claim 7, wherein: at least one of indium halide and thallium halide are further enclosed in said hollow discharge tube.

12. An infrared night-vision system, comprising:
a lamp unit having a hollow discharge tube; cesium halide enclosed in said hollow of said discharge tube; a near-infrared penetration filter covering around said discharge tube; and said lamp unit emits near-infrared light by electric discharge;
a light-receiving unit for receiving light reflected from irradiated subject based on near-infrared light, which is emitted from said lamp unit; and
a display unit that displays an image based on said reflected light received by said light-receiving unit.
